(19) United States
(12) Patent Application Publication
(10) Pub. No.: US 2007/0240734 A1
(43) Pub. Date: Oct. 18, 2007

(54) METHOD OF CLEANING POST-CMP WAFER

(76) Inventors: Ching-Wen Teng, Tao-Yuan Hsien (TW); Chin-Kun Lin, Kao-Hsiung City (TW); Yu-Hsiang Tseng, Ping-Tung Hsien (TW); Boon-Tiong Neo, Singapore (SG)

Correspondence Address: NORTH AMERICA INTELLECTUAL PROPERTY CORPORATION, P.O. BOX 506, MERRIFIELD, VA, 22116, US

(21) Appl. No.: 11/279,754

(22) Filed: Apr. 14, 2006

(51) Int. Cl. B08B 3/12; C23G 1/02; B08B 3/00; C23G 1/00

(52) U.S. Cl. 134/1; 134/2; 134/26; 134/28; 134/29; 134/3

(57) ABSTRACT

A post-CMP wafer is loaded into a buffer unit of a cleaning apparatus and is kept moist by adding a chemical. The post-CMP wafer is then loaded into a cleaning unit of the cleaning apparatus for performing the following cleaning process. The chemical added in the buffer unit is used to reduce the adhesion of benzotriazole (BTA) for improving the cleanliness of the post-CMP wafer.

### BACKGROUND OF THE INVENTION

1. Field of the Invention

The present invention relates to a method of cleaning a post-CMP wafer, and more particularly, to a method of cleaning a post Cu-CMP wafer.

2. Description of the Prior Art

Chemical-mechanical (CMP) is a process widely used in semiconductor fabrication and a technology often used to perform global planarization of a wafer. Furthermore, CMP is the only process that can provide global planarization in very-large scale integration (VLSI) and ultra-large scale integration (ULSI). A CMP process utilizes a slurry comprising proper chemical reagents and abrasives with mechanical polishing provided by a wafer grinding apparatus to perform planarization. In other words, the planarization provided by CMP is achieved by combining the chemical reaction provided by the chemicals with the mechanical polishing effect generated from the abrasive, the wafer, and the polishing pads. When each conditional parameter of a CMP process is properly set, a 94% even surface can be obtained.

The slurry used in a CMP process comprises abrasives such as silica or alumina and chemicals such as pH buffer, oxidants, or surfactants. The composition of the slurry is adjustable depending on different requirements. For example, a Cu-CMP slurry used in a Cu-CMP process further comprises 2% ammonium hydroxide and 1% hydrofluoric acid. In addition, because copper is apt to be oxidized and eroded, solutions comprising triazole are often added to Cu-CMP processes to protect the Cu pattern on the wafer and prevent it from eroding after the Cu-CMP process. For instance, benzotriazole (BTA) is added to the Cu-CMP slurry as a corrosion inhibitor for protecting the copper pattern.

After the CMP process, there is a great deal of abrasives and metal ions left on the surface of the wafer. Therefore, a cleaning process must be performed after the CMP process in order to get rid of those particles, metal ions, and organics. One of the cleaning methods for cleaning a post-CMP wafer is the wet chemical cleaning method. This is also the main method in the current technology. The wet chemical cleaning method comprises steps of cleaning the surface of a post-CMP wafer with an acid or base solution and deionized water, moisturizing the post-CMP wafer, and drying out the post-CMP wafer. However, instead of removing the particles from the post-CMP wafer, sometimes the wet chemical cleaning increases the possibility of particle attachment. Therefore, the wet chemical cleaning method is often performed with particle removing technology such as scrubbing, which utilizes brushes to scrub the surface of the post-CMP wafer, or with megasonic cleaning to remove particles and organic thin film from the surface of the post-CMP wafer.

Please refer to FIG. 1. FIG. 1 is a schematic drawing illustrating a conventional post-CMP wafer cleaning system. As shown in FIG. 1, a cleaning system 100 comprises a buffer area 102 in which a post-CMP wafer (not shown) is loaded. Before performing the following cleaning process in the buffer unit 102, the loaded post-CMP wafer is kept moist with deionized water. Then, the post-CMP wafer is loaded into the cleaning apparatus 104, which comprises a first cleaning area 106, a second cleaning area 108, a third cleaning area 110, a fourth cleaning area 112, and a spin-rinse-dry (SRD) device. Firstly, the post-CMP wafer undergoes megasonic cleaning in the first cleaning area 106 to remove particles. The post-CMP wafer is sequentially loaded into the second cleaning area 108 and the third cleaning area 110. An acid solution is added in the second cleaning area 108 to reduce the adhesion of BTA, and meanwhile, citric acid is added in order to protect copper from oxidization. And a base solution is added in the third area 110 to further reduce the adhesion of BTA. Next, the post-CMP wafer is loaded into the fourth area 112 to be cleaned by deionized water. In addition, scrubbing can be performed in the second cleaning area 108, the third cleaning area 110, and the fourth cleaning area 112 to brush the surface of the post-CMP wafer. After completing the abovementioned cleaning process, the post-CMP wafer is loaded into the SRD device in which steps of spinning, rinsing with deionized water, and drying are performed to remove water from the post-CMP wafer. In the end, the post-CMP wafer is loaded into a demounting area 116.

However, because BTA is adhesive, it is not easily removed, even with the acid and base solutions used to reduce the adhesion of BTA and respectively added in the second cleaning area and the third cleaning area. In other words, while the particles, the metal ions, and the organics are completely removed from the surface of the post-CMP wafer by performing the conventional cleaning process, BTA may still remain on the post-CMP wafer. Please refer to FIG. 2, which is a scanning electron microscopy (SEM) picture of a post-CMP wafer after performing the conventional cleaning process. As shown in FIG. 2, because the chemicals used to reduce the adhesion of BTA are added only in two areas among the cleaning process, the BTA is not completely removed and remains on the surface of the post-CMP wafer. More than that, BTA may form lumps on the surface of the post-CMP wafer, resulting in thermal effects, increase of resistance, or poor formation of the thin film afterwards. Therefore BTA is affirmed as an organic pollutant often found in the cleaning process for a post Cu-CMP wafer.

### SUMMARY OF THE INVENTION

It is therefore an object of the invention to provide a method of cleaning a post-CMP wafer to solve the problem of BTA remaining on the post-CMP wafer found after the conventional cleaning process.

The claimed invention provides a method of cleaning a post-CMP wafer which comprises loading a post-CMP wafer into a buffer unit with a chemical added to keep the post-CMP wafer moist, and loading the post-CMP wafer into a cleaning unit for performing cleaning process.

According to the method of cleaning post-CMP wafer provided by the present invention, the chemical added in the buffer unit is used to keep the post-CMP wafer moist and reduce the adhesion of BTA before performing the cleaning process. Because BTA can be completely removed by the method according to the present invention, the method is more favorable to be applied on post Cu-CMP wafers.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic drawing illustrating a conventional post-CMP wafer cleaning system.

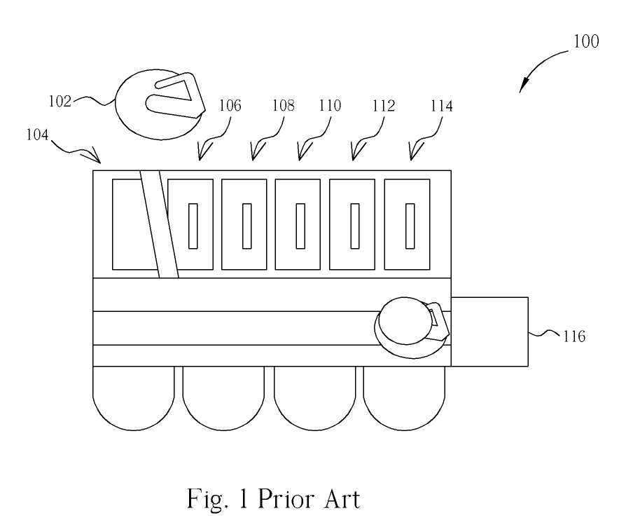

FIG. 2 is a SEM picture of a post-CMP wafer after the conventional cleaning process.

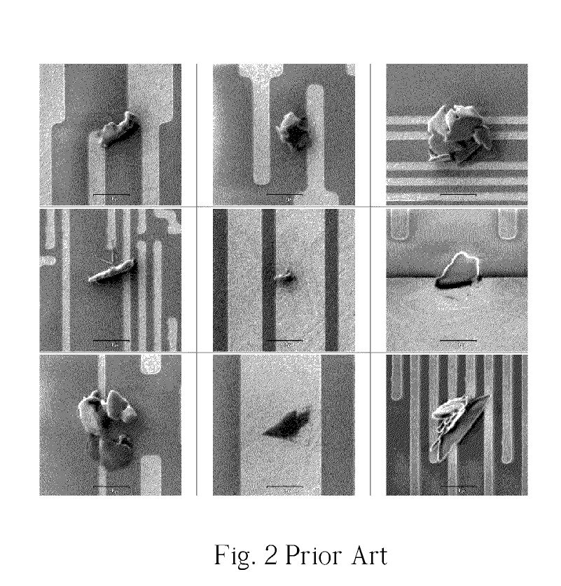

FIG. 3 is a flowchart illustrating a preferred embodiment of the method provided by the present invention.

FIG. 4 is a schematic drawing illustrating a cleaning apparatus according to the preferred embodiment.

### DETAILED DESCRIPTION

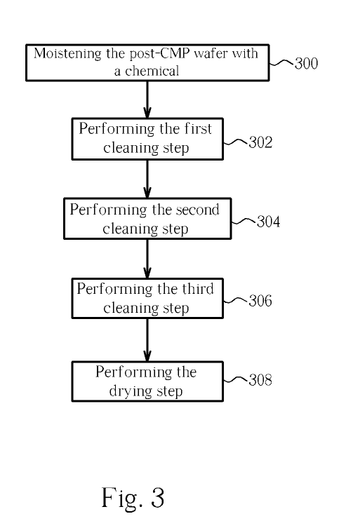

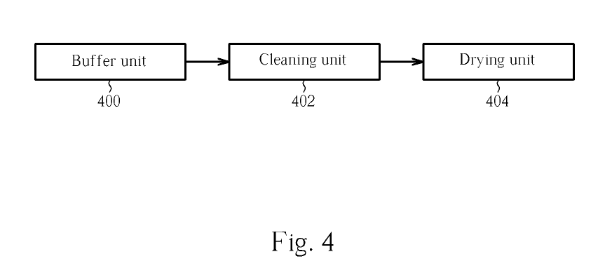

Please refer to FIG. 3, which is a flowchart illustrating a preferred embodiment of the method provided by the present invention; and please also refer to FIG. 4, which is a schematic drawing illustrating a cleaning apparatus according to the preferred embodiment of the method. As described in step 300, a post-CMP wafer is loaded into a buffer unit 400 of a cleaning apparatus before performing a cleaning process. A chemical used to keep the post-CMP wafer moist and reduce the adhesion of BTA is added by dropping or spraying onto the surface of the post-CMP wafer in step 300. The chemical comprises acid solutions such as citric acid, base solutions such as an amine-containing base solution, or organic solutions such as triethanolamine, ethylene glycol, or piperazine. In addition, the post-CMP wafer can be immersed in the abovementioned chemicals in the buffer unit 400.

Next, as described in steps 302, 304, and 306, the post-CMP wafer is loaded into a cleaning unit 402 of the cleaning apparatus to undergo a first cleaning step, a second cleaning step, and a third cleaning step. It is noteworthy that in this preferred embodiment, the cleaning unit 402 comprises a plurality of cleaning tanks to respectively perform each cleaning step, however, the cleaning steps can be performed in a single cleaning tank depending on the particular cleaning unit. In the first cleaning step, an acid solution such as citric acid is used to clean the post-CMP wafer by removing particles, metal ions, and organics. In the second cleaning step, a base solution such as an amine-containing solution is used to further clean the post-CMP wafer by removing remaining particles, metal ions, and organics. Deionized water is used in the third cleaning step to clean the post-CMP wafer by removing remaining particles, metal ions, organics, and remaining acid and base solution.

Thereafter, as described in step 308, the post-CMP wafer is moved from the cleaning unit 402 to a drying unit 404. The drying unit 404 can be a SRD device used to perform drying steps. Such steps can include spinning, rinsing with deionized water, and drying until the post-CMP wafer is completely dry.

As mentioned above, the preferred embodiment according to the method provided by the present invention includes the following steps:

Step 300: moistening the post-CMP wafer before the cleaning process with a chemical;

Step 302: performing the first cleaning step, which cleans the post-CMP wafer with an acid solution;

Step 304: performing the second cleaning step, which cleans the post-CMP wafer with a base solution;

Step 306: performing the third cleaning step, which cleans the post-CMP wafer with deionized water;

Step 308: performing the drying step.

In step 300, a step of rinsing the post-CMP wafer with deionized water can be further added after the post-CMP wafer is made moist with the chemical to assure the moistness of the wafer.

In addition, to improve the cleanliness of the post-CMP wafer and to get rid of particles, scrubbing can be performed respectively in steps 302, 304, and 306. Furthermore, a megasonic cleaning process can be performed before performing steps 302, 304, and 306 for removing the particles.

According to the preferred embodiment provided by the present invention, because the chemical added in the buffer unit effectively reduces the adhesion of BTA, BTA is sufficiently removed from the surface of the post-CMP wafer in the following cleaning process, resulting in improved cleaning quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of cleaning a post-CMP wafer comprising:
loading a post-CMP wafer into a buffer unit with a chemical added to keep the post-CMP wafer moist; and
loading the post-CMP wafer into a cleaning unit and performing a cleaning process.

2. The method of claim 1, wherein the chemical comprises an acid solution.

3. The method of claim 2, wherein the acid solution comprises citric acid.

4. The method of claim 1, wherein the chemical comprises a base solution.

5. The method of claim 4, wherein the base solution is an amine-containing base solution.

6. The method of claim 1, wherein the chemical comprises triethanolamine, ethylene glycol, or piperazine.

7. The method of claim 1, wherein the chemical is dropped into the buffer unit.

8. The method of claim 1, wherein the post-CMP wafer is immersed in the chemical within the buffer unit.

9. The method of claim 1 further comprising a step of rinsing the post-CMP wafer before performing the cleaning process.

10. The method of claim 1, wherein the cleaning process comprises steps of:
cleaning the post-CMP wafer with an acid solution;
cleaning the post-CMP wafer with a base solution;
cleaning the post-CMP wafer with deionized water;
scrubbing the post-CMP wafer; and
drying out the post-CMP wafer.

11. The method of claim 1, wherein the cleaning process further comprises a step of cleaning the post-CMP wafer with a megasonic process.

12. A method of cleaning a post Cu-CMP wafer comprising:
loading a post Cu-CMP wafer into a buffer unit with a chemical added to keep the post Cu-CMP wafer moist; and
loading the post Cu-CMP wafer into a cleaning unit and performing a cleaning process.

13. The method of claim 12, wherein the chemical comprises an acid solution.

14. The method of claim 13, wherein the acid solution comprises citric acid.

15. The method of claim 12, wherein the chemical comprises a base solution.

16. The method of claim 15, wherein the base solution is an amine-containing base solution.

17. The method of claim 12, wherein the chemical comprises triethanolamine, ethylene glycol, or piperazine.

18. The method of claim 12, wherein the chemical is dropped into the buffer unit.

19. The method of claim 12, wherein the post Cu-CMP wafer is immersed in the chemical in the buffer unit.

20. The method of claim 12 further comprising a step of rinsing the post Cu-CMP wafer before performing the cleaning process.

21. The method of claim 12, wherein the cleaning process comprises steps of:
cleaning the post Cu-CMP wafer with an acid solution;
cleaning the post Cu-CMP wafer with a base solution;
cleaning the post Cu-CMP wafer with deionized water;
scrubbing the post Cu-CMP wafer; and
drying out the post Cu-CMP wafer.

22. The method of claim 12, wherein the cleaning process further comprises a step of cleaning the post Cu-CMP wafer with a megasonic process.
